(19) United States
(12) Patent Application Publication
(10) Pub. No.: US 2011/0119373 A1
(43) Pub. Date: May 19, 2011

(54) SERVICE WORKFLOW GENERATION APPARATUS AND METHOD

(75) Inventors: Chen-Tung Chan, Taipei County (TW); Yun-Wei Liao, Taoyuan County (TW); Kuan-Yu Chen, Taipei County (TW); Chih-Hao Hsu, Taipei City (TW); Shyan-Ming Yuan, Hsinchu City (TW)

(73) Assignee: ASIA OPTICAL CO., INC., Taichung (TW)

(21) Appl. No.: 12/774,234

(22) Filed: May 5, 2010

(30) Foreign Application Priority Data
Nov. 17, 2009 (TW) 98138963

(51) Int. Cl. G06F 15/16

(52) U.S. Cl. 709/224

(57) ABSTRACT

A service workflow generation apparatus, having a quality of service (QoS) monitor for obtaining a plurality of real time QoS values respectively corresponding to a plurality of service elements on the web. A QoS calculation module generates a plurality of possible service workflows composed of the service elements and a plurality of overall QoS values of the possible service workflows based on the real time QoS values by using a Modified Heuristic Algorithm. A service workflow selection module dynamically selects a service workflow from the possible service workflows according to the overall QoS value.

### CROSS REFERENCE TO RELATED APPLICATIONS

This Non-provisional application claims priority under 35 U.S.C. §119(a) on Patent Application No(s). 098138963, filed in Taiwan on Nov. 17, 2009, the entire contents of which are hereby incorporated by reference.

### BACKGROUND OF THE INVENTION

1. Field of the Invention

The present invention relates to generation of service workflows, and in particular relates to a service workflow generation apparatus and method which considers a real time QoS value of the service elements of a service workflow in a network.

2. Description of the Related Art

Service-oriented architecture (SOA) is a method for constructing distributed system and used to package application functions as services and provide the services to subscribers. SOA can be implemented on various platforms such as public server machines, information servers, KIOSKs, and web servers, etc.

FIG. 1 is a schematic diagram showing a service workflow for SOA. A service workflow operated by a public server machine is usually composed of several services, where each of the services may be provided by computers, servers, workstations on the internet or intranet. For example, as shown in FIG. 1, the service workflow 100 is composed sequentially of the web service 1, web service 2 and web service 3. As an example, if the service workflow 100 is an electronic business workflow, the web services 1˜3 may be “recognition and authorization”, “network banking” and “order processing”, respectively. Each of the web services may be performed by one of the service elements provided by different service providers. For example, the service element 1 or the service element 2 may perform the “recognition and authorization”, the service element 3 or the service element 4 may perform the “network banking”, and the service element 5, service element 6 or service element 7 may perform the “order processing”. It is preset by developers during a design stage for selecting which service elements in a service workflow. In the example of FIG. 1, the service workflow 100 may be designed as the combination of the service element 1, service element 3 and service element 5.

A web service can be estimated based on the Quality of Service (QoS), and the QoS for the web service usually has a plurality of dimensions as follows:
(1) availability, representative of whether the web service is immediately available;
(2) accessibility, representative of the degree in which the web service is able to perform an issued request;
(3) integrity, representative of whether a complete web service is ensured;
(4) performance, for indicating the throughput and latency of the web service;
(5) security, representative of whether the web service provides encryption or access control;
(6) regulatory, representative of whether the web service operates in accordance with a standard procedure.
(7) reliability, representative of how often the web service is maintained at a high quality; and
(8) other standards.

Generally, the QoS of a running service element may fluctuate due to various reasons, affecting the QoS of the overall service workflow. For example, as the accessibility of the web service 1, recognition and authorization, decreases due to an overload of requests, the overall service workflow will also perform worse.

Generally, although the QoS of the service elements may be contemplated in the design stage of the service workflow, the QoS information used is out-of-date. Thus, the service workflow, when in operation, occasionally fails to work in expected performance due to mismatch between the QoS designed from out-of-date information and that of the most recent QoS Moreover, a genetic algorithm, which is used to optimize the combination of the service elements in the prior art, is an algorithm that requires much time. Thus the genetic algorithm is not suitable to be used online to dynamically adjust service workflows. Although prior art techniques have disclosed methods to replace the service elements by suspending workflows or restarting of workflows, they still fails to dynamically take the QoS information into account.

Therefore, a service workflow generation apparatus and method which dynamically considers a real time QoS value of the service elements of a service workflow in a network and ensures a complete operation of the service workflow without restarting it is desired.

### BRIEF SUMMARY OF THE INVENTION

The present invention provides a service workflow generation apparatus. The apparatus comprises: a quality of service (QoS) monitor for obtaining a plurality of real time QoS values respectively corresponding to a plurality of service elements on the web; a QoS calculation module for generating a plurality of possible service workflows composed of the service elements and a plurality of overall QoS values of the possible service workflows based on the real time QoS values by using a Modified Heuristic Algorithm; and a service workflow selection module for dynamically selecting a service workflow from the possible service workflows according to the overall QoS values.

The present invention further provides a service workflow generation method. The method comprises: obtaining a plurality of real time QoS values respectively corresponding to a plurality of service elements on the web; generating a plurality of possible service workflows composed of the service elements and a plurality of overall QoS values of the possible service workflows based on the real time QoS values by using a Modified Heuristic Algorithm; and dynamically selecting a service workflow from the possible service workflows according to the overall QoS values.

The present invention further provides a computer program readable by an electronic apparatus for performing a service workflow generation method. The service workflow generation method comprises: obtaining a plurality of real time QoS values respectively corresponding to a plurality of service elements on the web; generating a plurality of possible service workflows composed of the service elements and a plurality of overall QoS values of the possible service workflows based on the real time QoS values by using a Modified Heuristic Algorithm; and dynamically selecting a service workflow from the possible service workflows according to the overall QoS values.

A detailed description is given in the following embodiments with reference to the accompanying drawings.

### BRIEF DESCRIPTION OF THE DRAWINGS

The present invention can be more fully understood by reading the subsequent detailed description and examples with references made to the accompanying drawings, wherein:

FIG. 1 is a schematic diagram showing a service workflow;

FIG. 2 is a schematic diagram of a service workflow generation apparatus according to an embodiment of the present invention; and

FIG. 3 is a flow chart of the service workflow generation method according to an embodiment of the present invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

### Service Workflow Generation Apparatus

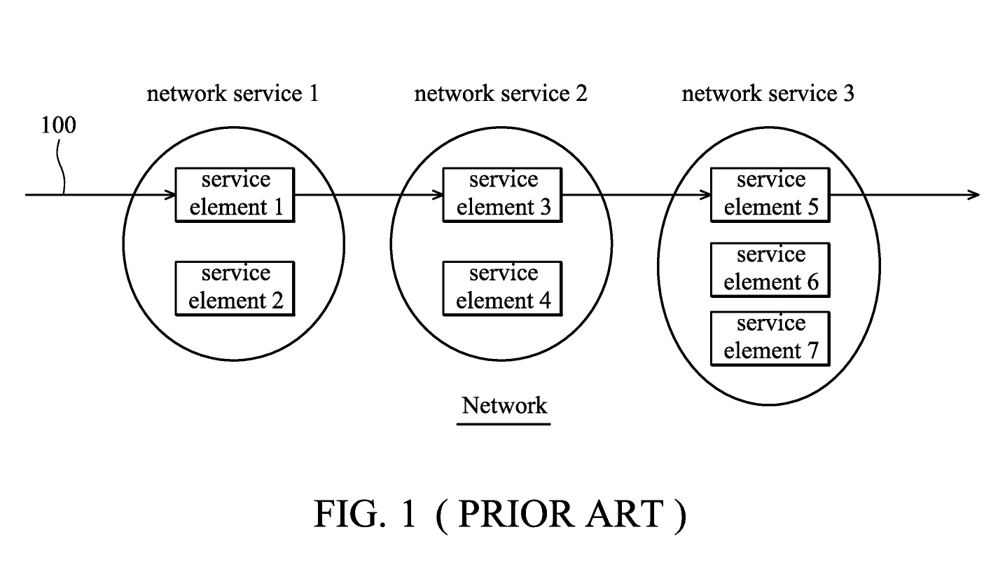

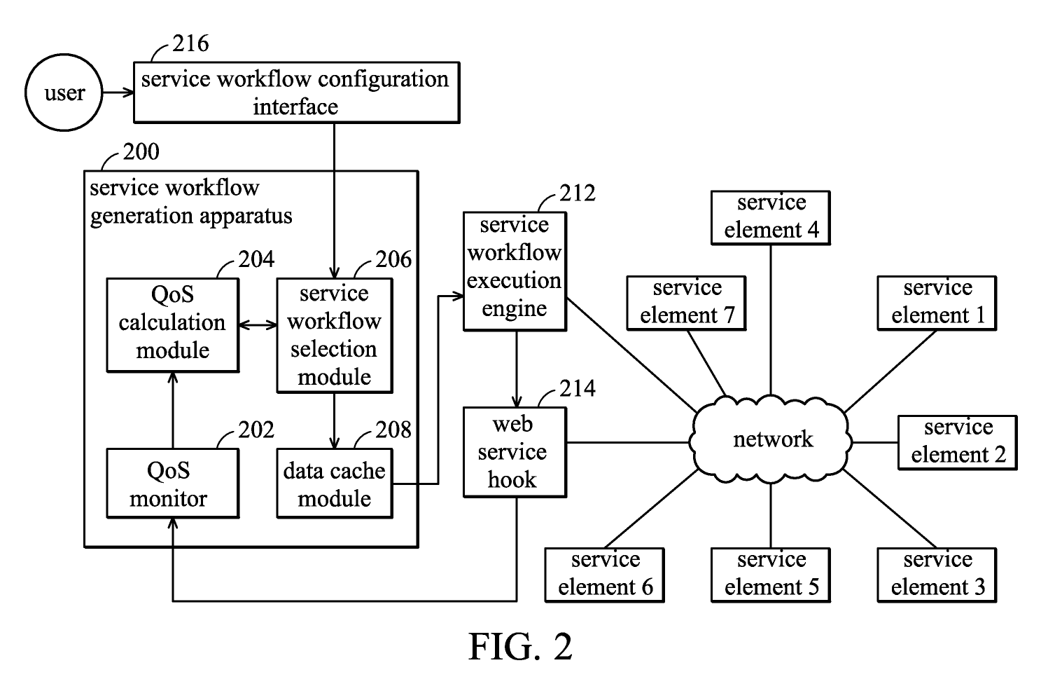

FIG. 2 is a schematic diagram of a service workflow generation apparatus according to an embodiment of the present invention. The service workflow generation apparatus 200 of the present invention can be implemented by a public service machine, KIOSK, web server or other apparatus which can cooperates with other computers via a network to provide services. The service workflow generation apparatus 200 comprises at least a QoS monitor 202, a QoS calculation module 204 and a service workflow selection module 206. For convenience, FIG. 1 is referred to with FIG. 2. In this embodiment, the service workflow 100 is composed of a plurality of web services (ex. services 1˜3), and each of the web services is performed by a service element. The service elements can be provided by other computers, servers or workstations. For illustration, the service workflow 100 in the embodiment is assumed to be composed of the service element 1, the service element 3 and the service element 5.

In another embodiment, the service workflow generation apparatus 200 is a public service machine which can communicate with other computers that provide service elements via a network. The apparatus 200 further comprises: a case; a network module which is disposed in the case and able to connect to other computers via a communications network (not shown in FIG. 2); the QoS monitor 202 disposed in the case and coupled to the network module for obtaining a plurality of real time QoS values respectively corresponding to a plurality of service elements on the web; and a processor which is disposed in the case, coupled to the QoS monitor 202 and executing the QoS calculation module 204 for generating a plurality of possible service workflows composed of the service elements and a plurality of overall QoS values of the possible service workflows based on the real time QoS values by using a Modified Heuristic Algorithm. The processor is also used to execute the service workflow selection module 206 to dynamically select a service workflow from the possible service workflows according to the overall QoS values. Moreover, the processor further operates a service workflow execution engine to execute the selected service workflow. The apparatus 200 further comprises a display (not shown) which is disposed in the case and coupled to the processor to display information about the status of the service workflows.

In an embodiment, the QoS monitor 202 connects with the service elements 1˜7 via a web service hook 214. The QoS monitor 202 of the present invention is used to obtain a plurality of real time QoS values respectively corresponding to service elements 1˜7 on the web, where the real time QoS value can be a developer-defined parameter, such as real time performance, response speed, or security, to estimate the quality of the service provided by each service element. Each QoS value of the service element has one or more than one dimensions as mentioned previously, which are: (1) availability; (2) accessibility; (3) integrity; (4) performance; (5) security; (6) regulatory; (7) reliability; and (8) other specific criterion for evaluating service elements. A higher QoS value may indicates worse QoS; alternatively, a higher QoS may sometimes indicate better QoS. For convenience, the following embodiments of the present invention are described based on the former criterion.

In other embodiments, the QoS monitor 202 can be implemented by various methods. For example, a timer or a signal transmitter can be used to estimate the accessibility and performance of the service elements. The timer or the signal transmitter can periodically transmit a test signal to the service elements of other computers or servers to estimate whether the service elements are accessible based on whether the service elements respond to the request. Also, the timer or the signal transmitter may estimate the performance of the service elements according to the time transpired to receive the response from the service elements. Moreover, the timer or the signal transmitter may estimate whether the security of the service elements or other specific criteria are met by using a storage apparatus which stores specific security testing components or other standard components.

According to the real time QoS value obtained by the QoS monitor 202, the QoS calculation module 204 further uses a Modified Heuristic Algorithm provided by the present invention to estimate all the possible service workflows which is composed of the service elements, and calculates the overall QoS of each of the possible service workflows. In this case, there are 12 (obtained by 2×3×3) possible service workflows, and each real time QoS values of the service elements has numerous dimensions. As such, the present invention provides a Modified Heuristic Algorithm to consider the dimensions in order to rapidly select one service workflow which meets an overall QoS requirement from the possible service workflows. The Modified Heuristic Algorithm will be discussed later.

The service workflow selection module 206 of the present invention, according to the overall QoS value of each of the possible workflows obtained by the QoS calculation module 204, dynamically selects a feasible service workflow from the possible service workflows. The service workflow selection module 206 can set an overall QoS threshold and select one which has an overall QoS value that is beyond the overall QoS threshold from the possible service workflows as the selected service workflow. Specifically, if the higher QoS value indicates worse QoS, the service workflow selection module 206 can select one which has an overall QoS value that is lower than the overall QoS threshold from the possible service workflows as the selected service workflow

Specifically, the wording “dynamically selecting a feasible service workflow” means that when the service workflow generation apparatus 200 determines that a running service element (for example, service element 3) of a running service workflow (which is composed of service elements 1, 3 and 5) has to be substituted, the service workflow generation apparatus 200 will suspend the running service element (service element 3), and dynamically select another feasible service workflow to substitute the unexecuted part of the original service workflow (for example, the new service workflow may be composed of service element 4 and 6). In this case, because the web service 1 is executed, the service element 1 will not be in the newly selected service workflow. The real time QoS value of the service element 3 of the web service 2 is substituted when it is beyond a preset QoS threshold due to delays or interruptions. When the service workflow generation apparatus 200 determines that a running service element of a running service workflow has to be substituted, the service workflow generation apparatus 200 suspends from the running service element and dynamically reselects a service workflow via the QoS monitor 202, the QoS calculation module 204 and the service workflow selection module 206. After executing the web service 3, the QoS calculation module 204 determined whether to use the preset service element 5.

In an embodiment, the feasible service workflow determined by the service workflow generation apparatus 200 of the present invention can be executed by a service workflow execution engine 212. In an embodiment, the service workflow execution engine 212 further connects to the service elements 1˜7 via the web service hook 214. Therefore, the service workflow generation apparatus 200 of the present invention can execute the service workflow via the service workflow execution engine 212 and the web service hook 214. The present invention does not limit the service workflow execution engine 212 to be a part of the service workflow generation apparatus 200. In another embodiment, the service workflow execution engine 212 can be implemented by other servers in the network.

In an embodiment, the service workflow generation apparatus 200 of the present invention further uses a service workflow configuration interface 216 to receive a preset service workflow preset by a user, and then executes the service workflow via the service workflow execution engine 21. The present invention comprises not only the special algorithm used to generate a feasible service workflow but also all the other mechanisms of the prior art.

Since the service workflow generation apparatus 200 of the present invention can dynamically update the service elements of the service workflow, in order to prevent users from repeatedly inputting the same data after substituting the running service element, the present invention provides a data cache module 208 to record the output data from the service elements of the selected service workflow exacted by the service workflow execution engine 212. Specifically, when the service workflow selection module 206 selects the substitute service workflow, the service workflow execution engine 212 1 outputs the output data as the input data to the substitute service workflow.

In some embodiments, the service workflow generation apparatus can connect to a computer which provides service elements online. The apparatus comprises: a case; a network module, disposed in the case, for connecting other computers via a communications network; a QoS monitor, disposed in the case, coupled to the network module, for obtaining a plurality of real-time QoS values respectively corresponding to a plurality of service elements on the web; and a processor, disposed in the case, coupled to the QoS monitor, executing a QoS calculation module for generating a plurality of possible service workflows composed of the service elements and a plurality of overall QoS values of the possible service workflows based on the real-time QoS values by using a Modified Heuristic Algorithm; and a service workflow selection module for dynamically selecting a service workflow from the possible service workflows according to the overall QoS values.

### Service Workflow Generation Method

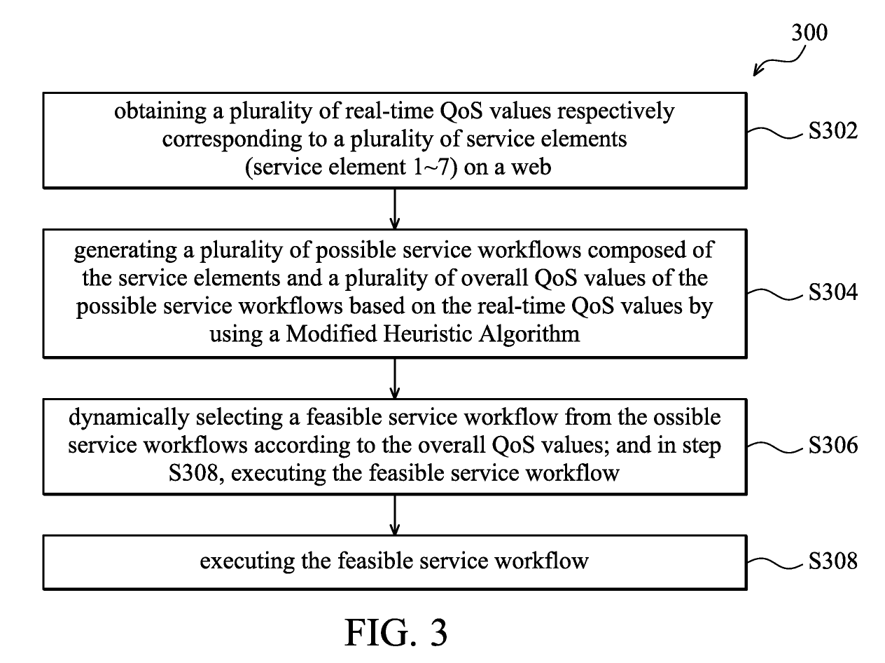

The present invention further provides a service workflow generation method. FIG. 3 is a flow chart of the service workflow generation method according to an embodiment of the present invention. Please refer to FIG. 3 and FIG. 1. The service workflow generation method 300 comprises: in step S302, obtaining a plurality of real time QoS values respectively corresponding to a plurality of service elements (such as service element 1˜7) on the web; in step S304, generating a plurality of possible service workflows composed of the service elements and a plurality of overall QoS values of the possible service workflows based on the real time QoS values by using a Modified Heuristic Algorithm; in step S306, dynamically selecting a feasible service workflow from the possible service workflows according to the overall QoS values; and in step S308, executing the feasible service workflow. However, since each of the QoS values of the service elements has a plurality of dimensions and thus the possible service workflows are numerous, the present invention provides a Modified Heuristic Algorithm to determine feasible solutions. The Modified Heuristic Algorithm will be discussed later.

In an embodiment, the service workflow generation method of the present invention further comprises setting an overall QoS threshold and dynamically selecting a feasible service workflow from the possible service workflows based on the overall QoS values and the overall QoS threshold (not shown in FIG. 3). In another embodiment, the service workflow generation method of the present invention further comprises: suspending from the running service element and dynamically selecting a substitute service workflow to substitute the unexecuted part of the original service workflow according to the foregoing steps S302˜S308 when determining that a running service element of a running service workflow has to be substituted (for example, when the real time QoS value of the running service element is beyond a real time QoS threshold). In another embodiment, the service workflow generation method of the present invention further comprises recording output data from the service elements of the selected service workflow exacted by the service workflow execution engine and outputting the output data as input data to the substitute service workflow when the running service workflow changes to another feasible substitute service workflow (not shown in Figs). In another embodiment, the service workflow generation method of the present invention further comprises using a service workflow configuration interface to receive a preset service workflow preset by a user (not shown in Figs).

The present invention further provides a computer program readable by an electronic apparatus to perform the foregoing service workflow generation method 300. The following is a description of the Modified Heuristic Algorithm of the present invention.

### Modified Heuristic Algorithm

(A) A Modified Heuristic Algorithm is used to determine feasible solutions for a given conditions, where the feasible solutions may be one or more than one. Methods for calculating each of the dimensions of the QoS of a service element are cited for instances as follows:
(a) calculation of accessibility: several request signals are sent periodically to each service element via the web service hook 214 and the number of response times may be obtained. For example, when sending 10 request signals and receiving 9 response times, the accessibility of the QoS is set to 0.9.
(b) calculation of performance: for example, the ratio between the time required for sending a request signal and receiving a response and a preset time.
(c) security: for example, determining whether the service element supports an SSL protocol, wherein the security is set as 1, when the service element supports the SSL protocol.

(B) The Modified Heuristic Algorithm of the present invention comprises the steps of: step: calculating the Resource value coefficient (RVC); and step: calculating the aggregated vector of each possible service workflows consume in each of the dimensions. An example is shown in table 1 below, where Si represents an i-th web service; Sij represents a j-th service element of an i-th web service; and Qk represents a k-th QoS of a service element:

TABLE 1

| | | Q1 | Q2 | Q3 |
|---|---|---|---|---|
| S₁ | S₁₁ | 20 | 5 | 5 |
| | S₁₂ | 5 | 10 | 20 |
| | S₁₃ | 40 | 5 | 5 |
| S₂ | S₂₁ | 20 | 30 | 20 |
| | S₂₂ | 60 | 30 | 5 |
| S₃ | S₃₁ | 80 | 20 | 40 |
| | S₃₂ | 30 | 70 | 60 |
| S₄ | S₄₁ | 20 | 5 | 5 |
| | S₄₂ | 5 | 10 | 10 |
| | S₄₃ | 20 | 20 | 10 |

In step, the RVC of each web service is calculated according to the resource value coefficient equation (equation 1) below. The results of the RVC of each web service are listed in table 2, where rkᵢⱼ is the k-th QoS of the service element Sᵢⱼ; resᵢⱼ is the RVC of the service element Sᵢⱼ, and bₖ is a real time QoS threshold for each service element and set as 100 herein for illustration:

$${res}_{ij} = \sqrt{{\sum }_{k = 1}^{m} ( \frac{{r}_{jij}}{{b}_{k}} )} \qquad ( Equation 1 )$$

TABLE 2

| | | Q1 | Q2 | Q3 | res |
|---|---|---|---|---|---|
| S₁ | S₁₁ | 20 | 5 | 5 | 0.21 |
| | S₁₂ | 5 | 10 | 20 | 0.23 |
| | S₁₃ | 40 | 5 | 5 | 0.46 |
| S₂ | S₂₁ | 20 | 30 | 20 | 0.41 |
| | S₂₂ | 60 | 30 | 5 | 0.67 |
| S₃ | S₃₁ | 80 | 20 | 40 | 0.92 |
| | S₃₂ | 30 | 70 | 60 | 0.97 |
| S₄ | S₄₁ | 20 | 5 | 5 | 0.21 |
| | S₄₂ | 5 | 10 | 10 | 0.15 |
| | S₄₃ | 20 | 20 | 10 | 0.3 |

When there is no solution found in step 1, the step 2 is processed to find the closest solutions which are though beyond the tolerance value. For example, step 2 may align the overall web services based on the lowest RVC of each of the web services, then align each of service elements based on the RVC of each of the web services (shown in Table 3), then select the web service element Sij having the lowest RVC for each of the web services Si (for example, select S₁₁ for S₁, select S₂₁ for S₂, select S₃₁ for S₃, and select S₄₁ for S₄), and then calculate the RVC aggregated vector of all the selected web service elements to determined whether the aggregated vector is lower than the QoS threshold. If yes, the combination of the S₁₁, S₂₁, S₃₁ and S₄₁ is the solution which meets the predetermined QoS threshold.

TABLE 3

| | | Q1 | Q2 | Q3 | res |
|---|---|---|---|---|---|
| S₁ | S₁₁ | 20 | 5 | 5 | 0.21 |
| | S₁₃ | 40 | 5 | 5 | 0.46 |
| | S₁₂ | 5 | 10 | 20 | 0.46 |
| S₄ | S₄₁ | 20 | 10 | 5 | 0.23 |
| | S₄₃ | 20 | 20 | 10 | 0.3 |
| | S₄₂ | 5 | 30 | 10 | 0.32 |
| S₂ | S₂₁ | 20 | 30 | 20 | 0.41 |
| | S₂₂ | 60 | 30 | 5 | 0.67 |
| S₃ | S₃₁ | 80 | 20 | 40 | 0.92 |
| | S₃₂ | 30 | 70 | 60 | 0.97 |

The amount consumed usdₖ and anruc values of each possible service workflows are calculated in step, where the anruc values are calculated to determine the solution values beyond and closest to the QoS threshold. The equations 2 for the usedₖ and the equation 3 for the anruc values are listed below:

$$\begin{matrix}{usd}_{k} = {\sum }_{j} {r}_{kj} & ( Equation 2 ) \\ anruc = \frac{1}{λ} {\sum }_{j} \frac{{used}_{j}}{{b}_{j}} & ( Equation 3 )\end{matrix}$$

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A service workflow generation apparatus, comprising:
a quality of service (QoS) monitor for obtaining a plurality of real time QoS values respectively corresponding to a plurality of service elements on the web;
a QoS calculation module for generating a plurality of possible service workflows composed of the service elements and a plurality of overall QoS values of the possible service workflows based on the real time QoS values by using a Modified Heuristic Algorithm; and
a service workflow selection module for dynamically selecting a service workflow from the possible service workflows according to the overall QoS values.

2. The service workflow generation apparatus as claimed in claim 1, wherein the service workflow selection module further sets an overall QoS threshold, and dynamically selects a service workflow from the possible service workflows based on the overall QoS values and the overall QoS threshold.

3. The service workflow generation apparatus as claimed in claim 2, wherein the service workflow selection module selects one of the possible service workflows, wherein the selected possible service workflow has an overall QoS value beyond the overall QoS threshold.

4. The service workflow generation apparatus as claimed in claim 1, wherein, when the service workflow generation apparatus determines that a running service element of a running service workflow has to be substituted, the service workflow generation apparatus suspends the running service element, and dynamically reselects a service workflow for the suspended service workflow via the QoS monitor, the QoS calculation module and the service workflow selection module, wherein the suspended service workflow comprises at least an unexecuted service element.

5. The service workflow generation apparatus as claimed in claim 4, wherein when the real time QoS value of the running service element beyond a QoS threshold corresponding to the running service element, the running service element has to be substituted.

6. The service workflow generation apparatus as claimed in claim 1, wherein the QoS monitor further connects with the service elements via a web service hook.

7. The service workflow generation apparatus as claimed in claim 1, wherein the service workflow generation apparatus further executes the selected service workflow via a service workflow execution engine.

8. The service workflow generation apparatus as claimed in claim 7, wherein:
the QoS monitor is further used for obtaining the real time QoS value of each of the service elements of the selected service workflow;
the QoS calculation module is further used for calculating an executed QoS value of the executed service elements of the selected service workflow; and
the service workflow selection module is further used for dynamically selecting a substitute service workflow for the unexecuted part of the selected service workflow when an executed QoS value is beyond the overall QoS threshold.

9. The service workflow generation apparatus as claimed in claim 8 further comprising:
a data cache module for recording output data from a service element of the selected service workflow executed by the service workflow execution engine, wherein the service workflow execution engine is further used for outputting the output data as input data to the substitute service workflow when the service workflow selection module selects the substitute service workflow.

10. The service workflow generation apparatus as claimed in claim 1, wherein the service workflow generation apparatus further uses a service workflow configuration interface to receive a preset service workflow preset by a user.

11. A service workflow generation method, comprising:
obtaining a plurality of real time QoS values respectively corresponding to a plurality of service elements on the web;
generating a plurality of possible service workflows composed of the service elements and a plurality of overall QoS values of the possible service workflows based on the real time QoS values by using a Modified Heuristic Algorithm; and
dynamically selecting a service workflow from the possible service workflows according to the overall QoS values.

12. The service workflow generation method as claim in claim 11, further comprising:
setting an overall QoS and dynamically selecting a service workflow from the possible service workflows based on the overall QoS values and the overall QoS threshold.

13. The service workflow generation method as claim in claim 12, further comprising:
selecting one of the possible service workflows, wherein the selected possible service workflow has an overall QoS value beyond the overall QoS threshold.

14. The service workflow generation method as claim in claim 12, further comprising:
when determining that a running service element of a running service workflow has to be substituted, suspending from the running service element, and dynamically reselecting a service workflow for the suspended service workflow according to the steps as claimed in claim 11.

15. The service workflow generation method as claim in claim 14, wherein when the real time QoS value of the running service element is beyond a QoS threshold corresponding to the running service element the service element has to be substituted.

16. The service workflow generation method as claim in claim 11, further comprising connecting to the service elements via a web service hook.

17. The service workflow generation method as claim in claim 11, further comprising executing the selected service workflow via a service workflow execution engine.

18. The service workflow generation method as claim in claim 17, further comprising:
obtaining the real time QoS value of each of the service elements of the selected service workflow;
calculating an executed QoS value of the executed service elements of the selected service workflow; and
dynamically selecting a substitute service workflow for the unexecuted part of the selected service workflow when an executed QoS value is beyond the overall QoS threshold.

19. The service workflow generation method as claim in claim 18, further comprising:
recording output data from service elements of the selected service workflow executed by the service workflow execution engine; and
outputting the output data as input data to the substitute service workflow when selecting the substitute service workflow.

20. A computer program readable by an electronic apparatus for performing a service workflow generation method, wherein the service workflow generation method comprises:
obtaining a plurality of real time QoS values respectively corresponding to a plurality of service elements on the web;
generating a plurality of possible service workflows composed of the service elements and a plurality of overall QoS values of the possible service workflows based on the real time QoS values by using a Modified Heuristic Algorithm; and
dynamically selecting a service workflow from the possible service workflows according to the overall QoS values.
